(19) United States
(12) Patent Application Publication
(10) Pub. No.: US 2021/0258782 A1
(43) Pub. Date: Aug. 19, 2021

(54) RADIO TRANSMISSION APPARATUS, MANAGEMENT APPARATUS, TRANSMISSION SYSTEM, TRANSMISSION METHOD, AND NON-TRANSITORY COMPUTER READABLE MEDIUM

(71) Applicant: NEC CORPORATION, Tokyo (JP)

(72) Inventor: Daisuke YOSHIOKA, Tokyo (JP)

(73) Assignee: NEC CORPORATION, Tokyo (JP)

(21) Appl. No.: 16/973,100

(22) PCT Filed: May 20, 2019
(86) PCT No.: PCT/JP2019/019874

§ 371 Date: Dec. 8, 2020

(30) Foreign Application Priority Data
Jun. 12, 2018 (JP) 2018-112049

(51) Int. Cl. H04W 12/06; H04W 12/63

(52) U.S. Cl. CPC H04W 12/06; H04W 88/06; H04W 12/63

(57) ABSTRACT

When a radio transmission apparatus is stolen and is used through another station in a state where a radio transmission path is not established, this fact is recognized and stop control of the stolen radio transmission apparatus is performed. A radio transmission apparatus (1) includes a control unit (1a), a first radio communication unit (1b) that performs radio communication by a first radio communication scheme, and a second radio communication unit (1c) that performs radio communication by a second radio communication scheme. The control unit (1a) performs radio communication using the second radio communication unit (1c) with another radio transmission apparatus which can perform radio communication by the first and the second radio communication schemes and in which a transmission path is not established by the first radio communication unit (1b). The control unit (1a) acquires authentication information and position information from the other radio transmission apparatus and executes authentication processing. The control unit (1a) controls the other radio transmission apparatus so as to stop a radio output when the authentication processing is successfully executed and a position of the other radio transmission apparatus indicated by the position information is not included in a predetermined area.

### TECHNICAL FIELD

The present disclosure relates to a radio transmission apparatus, a management apparatus, a transmission system, a transmission method, and a program.

### BACKGROUND ART

A transmission apparatus that performs desired data communication with another transmission apparatus may transmit management information such as setting information, control information, and state information of the transmission apparatus using a part of a transmission path for data communication. When this transmission path is a wired transmission path, the transmitting-side and the receiving-side apparatuses are physically connected to each other, so that the connectivity thereof is ensured.

However, when this transmission path is a wireless transmission path as in the case of a fixed radio transmission apparatus or the like, the transmission paths are not physically connected to each other, so that the connectivity thereof is not ensured. This makes it difficult to transmit the aforementioned management information. Therefore, if the transmission path is a wireless transmission path, there is a problem that when a radio transmission apparatus is stolen and is used through another station, it is impossible to recognize this fact or to perform stop control of the stolen radio transmission apparatus.

Patent Literature 1 discloses a mobile communication method and a network apparatus that are capable of detecting the relocation of an unauthorized home radio base station which a mobile network operator has not been notified about.

### CITATION LIST

### Patent Literature

Patent Literature 1: International Patent Publication No. WO 2009/148129

### SUMMARY OF INVENTION

### Technical Problem

However, the mobile communication method disclosed in Patent Literature 1 is a technique based on the premise that a radio transmission path is established, so that in a case where a radio transmission apparatus is stolen and is used through another station in a state where a radio transmission path is not established, it is impossible to recognize this fact or to perform stop control of the stolen radio transmission apparatus.

An object of the present disclosure is to provide a radio transmission apparatus, a management apparatus, a transmission system, a transmission method, and a program that solve the above-described problem. The above-described problem is that when a radio transmission apparatus is stolen and is used through another station in a state where a radio transmission path is not established, it is impossible to recognize this fact or to perform stop control of the stolen radio transmission apparatus.

### Solution to Problem

A radio transmission apparatus according to a first aspect of the present disclosure includes:

a first radio communication unit configured to perform radio communication by a first radio communication scheme;

a second radio communication unit configured to perform radio communication by a second radio communication scheme; and

a control unit configured to perform radio communication using the second radio communication unit with another radio transmission apparatus which is configured to be able to perform radio communication by the first and the second radio communication schemes and in which a transmission path is not established with the radio transmission apparatus by the first radio communication unit, acquire authentication information and position information from the other radio transmission apparatus, execute authentication processing of the other radio transmission apparatus, and control the other radio transmission apparatus so as to stop a radio output when the authentication processing is successfully executed and a position of the other radio transmission apparatus indicated by the position information is not included in a predetermined area.

A management apparatus according to a second aspect of the present disclosure includes:

a communication unit configured to communicate with a radio transmission apparatus configured to be able to perform radio communication by a first radio communication scheme and a second radio communication scheme via a base station for performing radio communication by the second radio communication scheme; and

control unit configured to perform communication including radio communication by the second radio communication scheme using the communication means with another radio transmission apparatus which is configured to be able to perform radio communication by the first and the second radio communication schemes and in which a transmission path using the first radio communication scheme is not established with the radio transmission apparatus, acquire authentication information and position information from the other radio transmission apparatus, execute authentication processing of the other radio transmission apparatus, and control the other radio transmission apparatus so as to stop a radio output when the authentication processing is successfully executed and a position of the other radio transmission apparatus indicated by the position information is not included in a predetermined area.

A transmission system according to a third aspect of the present disclosure includes: a radio transmission apparatus configured to be able to perform radio communication by a first radio communication scheme and a second radio communication scheme; another radio transmission apparatus configured to be able to perform radio communication by the first and the second radio communication schemes; and a management apparatus,
in which the management apparatus includes:
   a communication unit configured to communicate with the radio transmission apparatus via a base station for performing radio communication by the second radio communication scheme; and
   a control unit configured to perform communication including radio communication by the second radio communication scheme using the communication unit with the other radio transmission apparatus which is configured to be able to perform radio communication by the first and the second radio communication schemes and in which a transmission path using the first radio communication scheme is not established with the radio transmission apparatus, acquire authentication information and position information from the other radio transmission apparatus, execute authentication processing of the other radio transmission apparatus, and control the other radio transmission apparatus so as to stop a radio output when the authentication processing is successfully executed and a position of the other radio transmission apparatus indicated by the position information is not included in a predetermined area.

A transmission method according to a fourth aspect of the present disclosure includes:

causing a radio transmission apparatus configured to be able to perform radio communication by a first radio communication scheme and a second radio communication scheme to detect that a transmission path using the first radio communication scheme is not established with another radio transmission apparatus configured to be able to perform radio communication by the first and the second radio communication schemes; and

causing the radio transmission apparatus, or a management apparatus connected to the radio transmission apparatus via a base station for performing radio communication by the second radio communication scheme to: perform communication including radio communication by the second radio communication scheme with the other radio transmission apparatus in which it is detected that the transmission path is not established; acquire authentication information and position information from the other radio transmission apparatus; execute authentication processing of the other radio transmission apparatus; and control the other radio transmission apparatus so as to stop a radio output when the authentication processing is successfully executed and a position of the other radio transmission apparatus indicated by the position information is not included in a predetermined area.

A program according to a fifth aspect causes a computer of a radio transmission apparatus configured to be able to perform radio communication by a first radio communication scheme and a second radio communication scheme or a computer of a management apparatus connected to the radio transmission apparatus via a base station for performing radio communication by the second radio communication scheme to:

detect that a transmission path using the first radio communication scheme is not established between the radio transmission apparatus and another radio transmission apparatus configured to be able to perform radio communication by the first and the second radio communication schemes; and

perform communication including radio communication by the second radio communication scheme with the other radio transmission apparatus in which it is detected that the transmission path is not established, acquire authentication information and position information from the other radio transmission apparatus, execute authentication processing of the other radio transmission apparatus, and control the other radio transmission apparatus so as to stop a radio output when the authentication processing is successfully executed and a position of the other radio transmission apparatus indicated by the position information is not included in a predetermined area. Advantageous Effects of Invention

According to the present disclosure, it is possible to provide a radio transmission apparatus, a management apparatus, a transmission system, a transmission method, and a program that solve the above-described problem. That is, according to the present disclosure, when a radio transmission apparatus is stolen and is used through another station in a state where a radio transmission path is not established, it is possible to recognize this fact or to perform stop control of the stolen radio transmission apparatus.

### BRIEF DESCRIPTION OF DRAWINGS

FIG. 1 is a block diagram showing an example of a configuration of a radio transmission apparatus according to a first example embodiment;

FIG. 2 is a schematic diagram showing an example of a configuration of a transmission system including a radio transmission apparatus according to a second example embodiment;

FIG. 3 is a block diagram showing an example of a configuration of a fixed radio transmission apparatus in the communication system shown in FIG. 2;

FIG. 4 is a block diagram showing a fixed radio transmission apparatus according to a comparative example;

FIG. 5 is a diagram showing an example of a network configuration in the transmission system according to the second example embodiment;

FIG. 6 is a block diagram for explaining a flow of control performed between fixed radio transmission apparatuses in the transmission system shown in FIG. 5;

FIG. 7 is a flowchart for explaining the flow of control performed between the fixed radio transmission apparatuses in the transmission system shown in FIG. 5;

FIG. 8 is a diagram showing an example of a configuration of a transmission system according to a third example embodiment;

FIG. 9 is a diagram showing an example of a configuration of a transmission system according to a fourth example embodiment; and

FIG. 10 shows an example of a hardware configuration of each of the apparatuses.

### DESCRIPTION OF EMBODIMENTS

Hereinafter, examples embodiments will be described with reference to the drawings. Note that the same or equivalent components may be denoted by the same reference symbols throughout the example embodiments, and redundant descriptions will be omitted.

### FIRST EXAMPLE EMBODIMENT

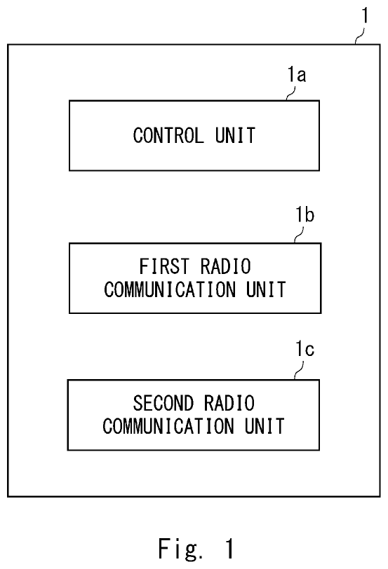

FIG. 1 is a block diagram showing an example of a configuration of a radio transmission apparatus according to a first example embodiment.

As shown in FIG. 1, a radio transmission apparatus 1 according to this example embodiment includes a control unit 1a, a first radio communication unit 1b, and a second radio communication unit 1c. The radio transmission apparatus 1 can be, for example, a portable terminal apparatus such as a mobile phone (including one referred to as a smartphone) and a mobile Personal Computer (PC).

The control unit la can be implemented by, for example, a Central Processing Unit (CPU), a work memory, and a nonvolatile storage device storing a control program. Further, the control unit 1a may be implemented by, for example, an integrated circuit. The control performed by the control unit 1a will be described later.

The first radio communication unit 1b performs radio communication by a first radio communication scheme. Further, the second radio communication unit 1c performs radio communication by a second radio communication scheme. As described above, the radio transmission apparatus 1 is an apparatus capable of performing radio communication by at least two different radio communication schemes (two radio communication schemes having different characteristics). Here, the second radio communication scheme can be, for example, a radio communication scheme having a wider communication range than that of the first radio communication scheme, but it is not limited to such a radio communication scheme.

The radio transmission apparatus 1 can function as an apparatus that monitors one or more other radio transmission apparatuses capable of performing radio communication by the first and the second radio communication schemes in the same manner as the radio communication performed by each of the first and the second radio communication units 1b and 1c. Therefore, the control unit 1a performs the following control.

The control unit 1a performs, using the second radio communication unit 1c, radio communication with the other radio transmission apparatus in which a transmission path (a radio communication transmission path) is not established with the radio transmission apparatus 1 by the first radio communication unit 1b. The other radio transmission apparatus belongs to the aforementioned one or more other radio transmission apparatuses. In other words, when a transmission path is not established with a radio transmission apparatus, which is a communication target, by the first radio communication unit 1b, the control unit 1a performs radio communication with this radio transmission apparatus by using the second radio communication unit 1c. The control unit 1a can directly perform such radio communication using the second radio communication unit 1c with the other radio transmission apparatus in which the aforementioned transmission path is not established, or perform it with the other radio transmission apparatus via another new radio transmission apparatus.

It is possible to determine whether the above-described transmission path is established, for example, by providing the control unit 1a with an abnormality determination unit that determines whether an abnormality has occurred in radio communication performed by the first radio communication unit 1b.

By the aforementioned radio communication, the control unit la acquires authentication information and position information from the other radio transmission apparatus (the radio transmission apparatus which is a target of the radio communication), and executes authentication processing of the other radio transmission apparatus. Further, the control unit 1a stops, by the aforementioned radio communication, a radio output of the other radio transmission apparatus when the authentication processing is successfully executed and the position of the other radio transmission apparatus indicated by the acquired position information is not included in a predetermined area (range). The control unit 1a performs such control for stopping a radio output of the other radio transmission apparatus by using the second radio communication unit 1c.

According to this example embodiment, when a radio transmission apparatus is stolen and is used through another station in a state where a radio transmission path is not established, it is possible to recognize this fact or to perform stop control of the stolen radio transmission apparatus. Further, according to this example embodiment, as communication by the first radio communication scheme performed by the stolen apparatus located within a predetermined range (area) is stopped, it is possible to prevent unauthorized use of the stolen apparatus. For example, even when a user has lost a portable terminal apparatus and the lost portable terminal apparatus is moved out of the communication area of the first radio communication scheme, it is possible to perform stop control of the lost portable terminal apparatus by the second radio communication scheme from a second portable terminal apparatus or the like, and it is thus possible to prevent unauthorized use.

### SECOND EXAMPLE EMBODIMENT

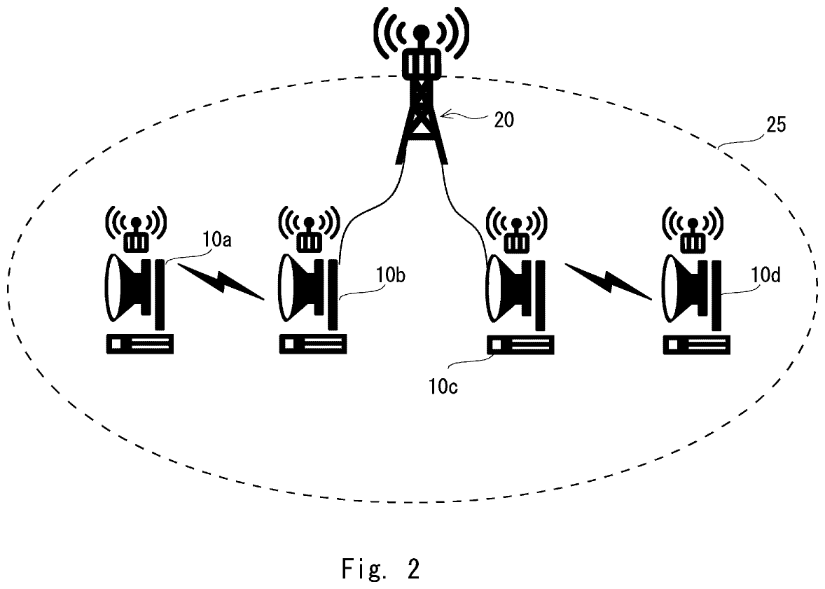

A second example embodiment will be described with reference to FIGS. 2 to 7, with a focus on differences between it and the first example embodiment, but various examples described in the first example embodiment can be applied to the second example embodiment. FIG. 2 is a schematic diagram showing an example of a configuration of a transmission system including a radio transmission apparatus according to the second example embodiment.

As shown in FIG. 2, the transmission system according to this example embodiment can include fixed radio transmission apparatuses 10a, 10b, 10c, and 10d and a Low Power Wide Area (LPWA) base station 20. The fixed radio transmission apparatuses 10a, 10b, 10c, and 10d are configured to be able to perform LPWA communication as an example of the second radio communication scheme, for example, via the LPWA base station 20. In the following description, any of the fixed radio transmission apparatuses 10a, 10b, 10c, and 10d is referred to as the fixed radio transmission apparatus 10 when a specific fixed radio transmission apparatus is not being referred to. Note that the configuration shown in FIG. 2 is merely an example. The example in FIG. 2 shows the four fixed radio transmission apparatuses 10, but the transmission system may include any number of fixed radio transmission apparatuses 10.

The fixed radio transmission apparatus 10 is an apparatus that performs point-to-point communication with another fixed radio transmission apparatus 10. In the example shown in FIG. 2, the fixed radio transmission apparatuses 10a and 10b perform one-to-one communication, and the fixed radio transmission apparatuses 10c and 10d perform one-to-one communication. For example, a high-speed fixed radio transmission apparatus used in a backhaul of a mobile communication network or a telephone network can be used as the fixed radio transmission apparatus 10. However, for example, the fixed radio transmission apparatus 10 may be an apparatus used for other purposes, such as an apparatus used as an alternative to a common wired transmission path (e.g., an Ethernet (registered trademark) line).

The fixed radio transmission apparatus 10 can perform LPWA communication with the LPWA base station 20 as described above in addition to communication with another fixed radio transmission apparatus 10. In the following description, a transmission path through which the fixed radio transmission apparatus 10 performs point-to-point communication with another fixed radio transmission apparatus 10 is referred to as a main transmission path, and a transmission path through which the fixed radio transmission apparatus 10 performs LPWA communication is referred to as an LPWA transmission path. In this example embodiment, the main transmission path provides faster communication than that in the LPWA transmission path.

The LPWA base station 20 is a base station that performs point-to-multipoint LPWA communication with the fixed radio transmission apparatus 10 in a radio wave coverage area 25 (which is a broken-line area in FIG. 2 and may also be referred to as a core) of LPWA communication.

Further, each of the fixed radio transmission apparatuses 10 can function as an example of the radio transmission apparatus 1, and can also function as an example of the other radio transmission apparatus. That is, the fixed radio transmission apparatus 10 is an apparatus that can be both a stolen apparatus and a monitoring apparatus.

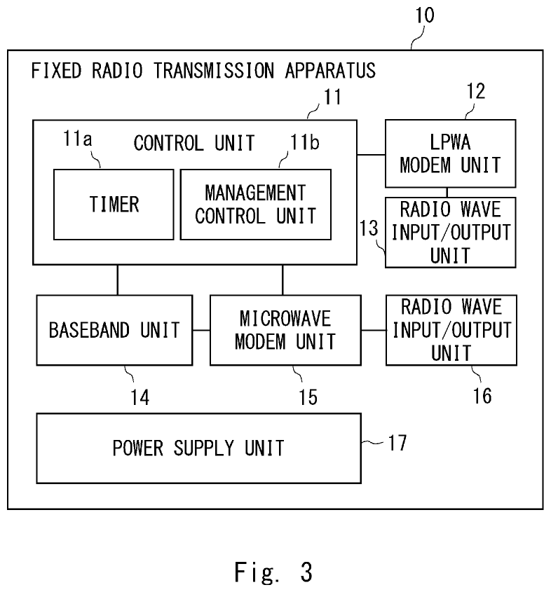

Next, a detailed example of the fixed radio transmission apparatus 10 is described with reference to FIG. 3. FIG. 3 is a block diagram showing an example of a configuration of the fixed radio transmission apparatus 10 in a communication system shown in FIG. 2.

As shown in FIG. 3, the fixed radio transmission apparatus 10 may include a control unit 11, an LPWA modem unit 12, a radio wave input/output unit 13, a baseband unit 14, a microwave modem unit 15, a radio wave input/output unit 16, and a power supply unit 17.

The control unit 11 includes a CPU and the like, and controls the fixed radio transmission apparatus 10. The control unit 11 may include a timer 11a and a management control unit 11b. The timer 11a counts a period during which an administrator is to determine that an apparatus is a stolen one, and the period can be set in advance by the administrator. The management control unit 11b manages authentication information which is information used for authentication of its own apparatus (i.e., the fixed radio transmission apparatus 10) and position information indicating the position of its own apparatus. In order to acquire position information, the fixed radio transmission apparatus 10 may include a position information acquisition unit such as a Global Positioning System (GPS).

The LPWA modem unit 12 and the radio wave input/output unit 13 are circuits for constructing the LPWA transmission path, have a function of performing LPWA communication, and perform communication between apparatuses by a wide-area radio transmission scheme. The LPWA modem unit 12 performs modulation and demodulation (a main signal conversion to the radio input/output unit 13) in accordance with the LPWA transmission path, and the radio wave input/output unit 13 controls LPWA communication with the outside.

The baseband unit 14, the microwave modem unit 15, and the radio wave input/output unit 16 are circuits for constructing the main transmission path. The baseband unit 14 controls a main signal. The microwave modem unit 15 performs modulation and demodulation (a main signal conversion from the baseband unit 14 to the radio wave input/output unit 16) in accordance with the main transmission path, and the radio wave input/output unit 16 controls radio communication with the outside.

It should be noted that a transmission path that provides Fixed Wireless Access (FWA) communication can be used as the main transmission path. The main transmission path is a transmission path defined by a predetermined point-to-point radio communication scheme using microwaves. Each of the microwave modem unit 15 and the radio wave input/output unit 16 corresponds to an example of the first radio communication unit 1b shown in FIG. 1, and performs radio communication (radio communication by the first radio communication scheme) by FWA. Each of the LPWA modem unit 12 and the radio wave input/output unit 13 corresponds to an example of the second radio communication unit 1c shown in FIG. 1, and performs radio communication (radio communication by the second radio communication scheme) by LPWA. FWA communication enables higher speed transmission than that in LPWA communication. Note that in this example embodiment, as the LPWA communication is used as the second radio communication scheme, the communication range thereof is wider than that of the first radio communication scheme. Further, in this example embodiment, as the LPWA communication is used as the second radio communication scheme, point-to-multipoint communication can be performed among the LPWA base station 20 and a plurality of fixed radio transmission apparatuses 10.

Further, the radio wave input/output unit 13 is an interface circuit for transmitting and receiving radio waves to and from the LPWA base station 20, and includes, for example, an antenna. The radio wave input/output unit 13 transmits a signal output from the LPWA modem unit 12. Further, the radio wave input/output unit 13 outputs the received signal to the LPWA modem unit 12. The radio wave input/output unit 16 is an interface circuit for transmitting and receiving radio waves to and from another fixed radio transmission apparatus 10, and includes, for example, an antenna. The radio wave input/output unit 16 transmits a signal output from the microwave modem unit 15 to space. Further, the radio wave input/output unit 16 outputs the signal received from the space to the microwave modem unit 15.

The fixed radio transmission apparatus 10 can include, inside or outside the control unit 11, a data transfer processing unit (not shown) that performs switching between the main transmission path and the LPWA transmission path to perform transmission. Specifically, this data transfer processing unit is, for example, a network switch such as an L2 (Layer 2) switch. The data transfer processing unit can transmit information such as management information through a specified transmission path, which is either the main transmission path or the LPWA transmission path.

Note that as the FWA communication and the LPWA communication used in this example embodiment, any known communication technology (communication standards) can be employed. In particular, the LPWA used in this example embodiment may be an LPWA using a unique network or an LPWA using a mobile phone network. Examples of the LPWA using a unique network include Long Range Wide Area Network (LoRaWAN) (registered trademark), SigFox (registered trademark), and Wi-Fi HaLow (IEEE 802.11ah). Note that LPWAs other than those described above that use a unique network, which are implemented in accordance with a unique protocol or the like, may be employed in this example embodiment. Further, examples of the LPWA using a mobile telephone network include 3GPP LTE-M and 3GPP NB-IOT, but the LPWA is not limited to these. Further, as an example of the second radio communication scheme, a wide-area radio communication scheme capable of performing radio communication at a place where the fixed radio transmission apparatus 10 is installed is used, and as an example of the wide-area radio communication scheme, a scheme in which LPWA communication is performed is used. Although a wide-area radio communication technology is not limited to a particular technology, it is more effective to use radio communication performed by the LPWA technology than that performed by other technologies in view of the former technology's low power consumption, high coverage, and capability of accommodating a large number of apparatuses.

Further, the fixed radio transmission apparatus 10 includes the power supply unit 17 that supplies power to the components of the fixed radio transmission apparatus 10. The power supply unit 17 supplies power to at least the baseband unit 14, the microwave modem unit 15, and the radio wave input/output unit 16, but as a matter of course, the power supply unit 17 can be configured to supply power to the components of the fixed radio transmission apparatus 10 other than the above ones.

The control unit 11 is an example of the control unit la described above, and performs LPWA communication with the other radio transmission apparatus 10 in which a main transmission path is not established with its own apparatus by microwave. The other radio transmission apparatus 10 belongs to the fixed radio transmission apparatuses 10 in the coverage area 25. The control unit 11 can determine whether an abnormality has occurred in the radio communication through the main transmission path, for example, based on state values of predetermined monitoring items output from the microwave modem unit 15. The monitoring items can indicate various kinds of states such as a setting state, a control state, and an operation state of the fixed radio transmission apparatus 10. For example, the control unit 11 can acquire information indicating various kinds of states from the data transfer processing unit, the LPWA modem unit 12, the microwave modem unit 15, the radio wave input/output units 13 and 16, or other components (not shown) of the fixed radio transmission apparatus 10.

The control unit 11 acquires authentication information and position information in the management control unit 11b from the other fixed radio transmission apparatus 10 by the LPWA communication, and executes authentication processing of the other fixed radio transmission apparatus 10. Further, the control unit 11 stops a radio output of the other fixed radio transmission apparatus 10 by the LPWA communication when the authentication processing is successfully executed and the position of the other fixed radio transmission apparatus 10 indicated by the acquired position information is not included in a predetermined area (range). The control unit 11, for example, by controlling the power supply unit 17, can stop supplying power to the baseband unit 14, the microwave modem unit 15, and the radio wave input/output unit 16 and stop a radio output. Further, the control unit 11 can stop the radio wave input/output unit 16 from inputting and outputting microwaves, for example, by way of the microwave modem unit 15.

As described above, in this example embodiment, LPWA communication is used as the second radio communication scheme. That is, as the second radio communication scheme, a radio communication scheme having a wider communication range than that of the first radio communication scheme (exemplified by FWA communication) is used. Thus, the fixed radio transmission apparatus 10 can communicate, by the second radio communication scheme, with another fixed radio transmission apparatus 10 that can no longer establish communication by the first radio communication scheme, and can also perform stop control by this communication.

Further, in this example embodiment, a radio communication scheme in which point-to-multipoint communication is performed is used as the second radio communication scheme. Thus, it is possible to simultaneously perform stop control of the plurality of fixed radio transmission apparatuses 10 serving as apparatuses (apparatuses to be monitored) on the other end of transmission, simultaneously transmit and receive management information or the like to and from these apparatuses, and so on. Further, in point-to-multipoint communication, setting and adjustment required for establishing communication are easier than those for establishing point-to-point FWA communication. Thus, it is possible to easily perform stop control and transmission of management information or the like. Note that the example is given in which the first radio communication scheme is a radio communication scheme in which point-to-point communication is performed and the second radio communication scheme is a radio communication scheme in which point-to-multipoint communication is performed, but the first and the second radio communication schemes are not limited to these schemes.

Next, an example of an operation performed by a transmission system according to this example embodiment is described.

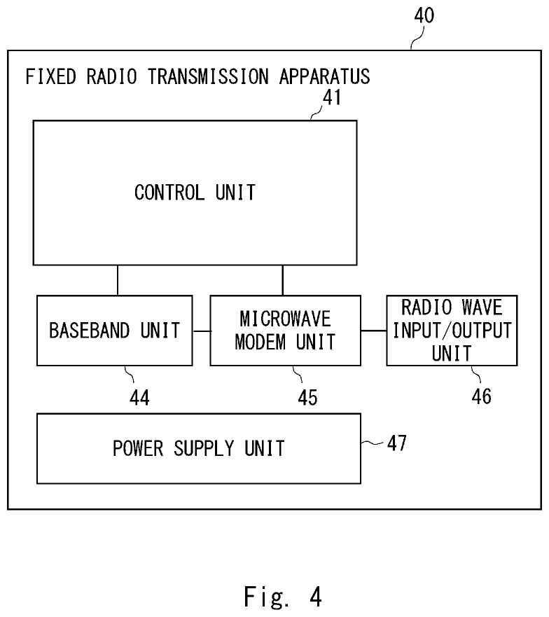

First, a comparative example is described with reference to FIG. 4. FIG. 4 is a block diagram showing a fixed radio transmission apparatus according to the comparative example. As shown in FIG. 4, a fixed radio transmission apparatus 40 according to the comparative example includes a control unit 41, a baseband unit 44, a microwave modem unit 45, and a radio wave input/output unit 46. However, the fixed radio transmission apparatus 40 does not have a function of acquiring authentication information and position information of an opposing apparatus, unlike the management control unit 11b of the fixed radio transmission apparatus 10. Therefore, the fixed radio transmission apparatus 40 cannot specify and control a stolen apparatus by remote monitoring.

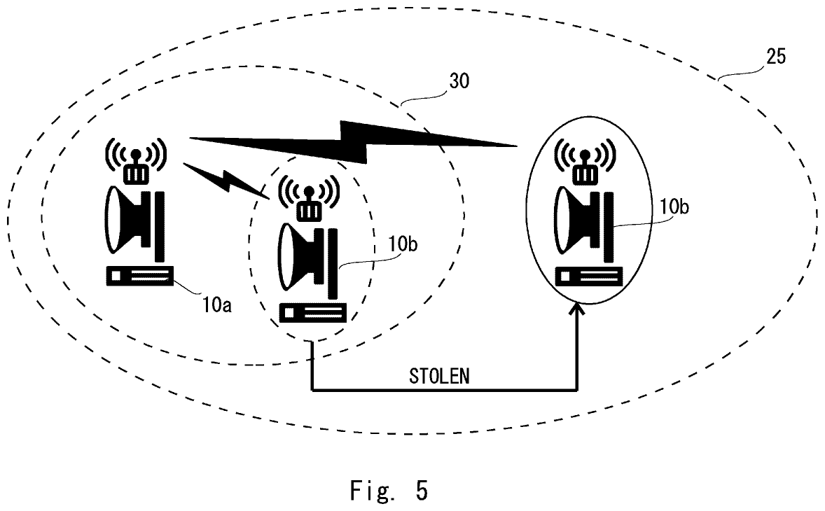

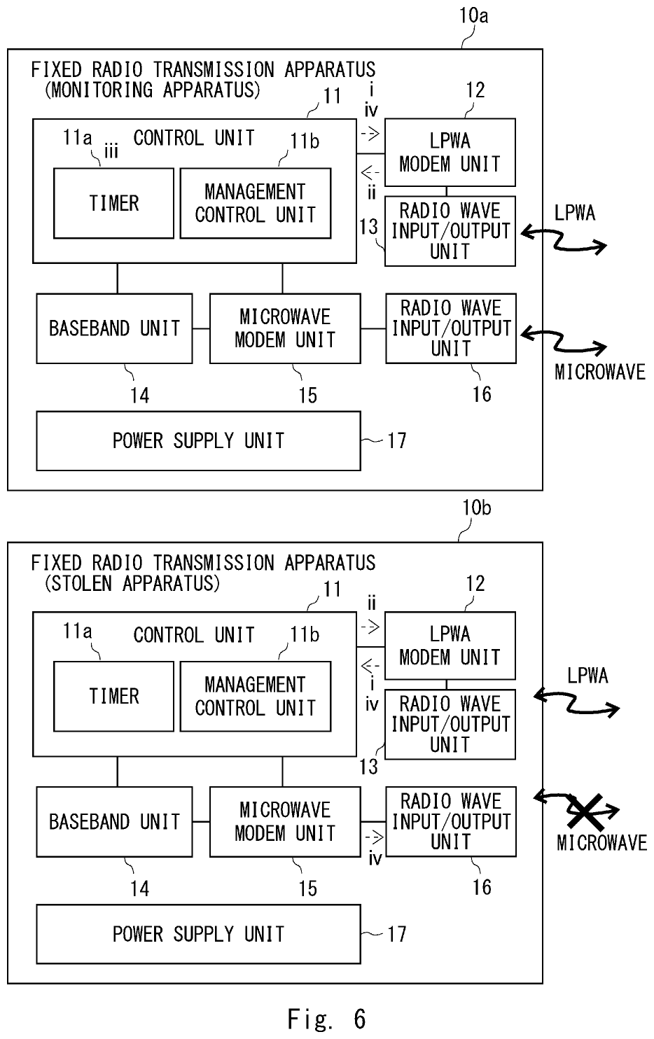

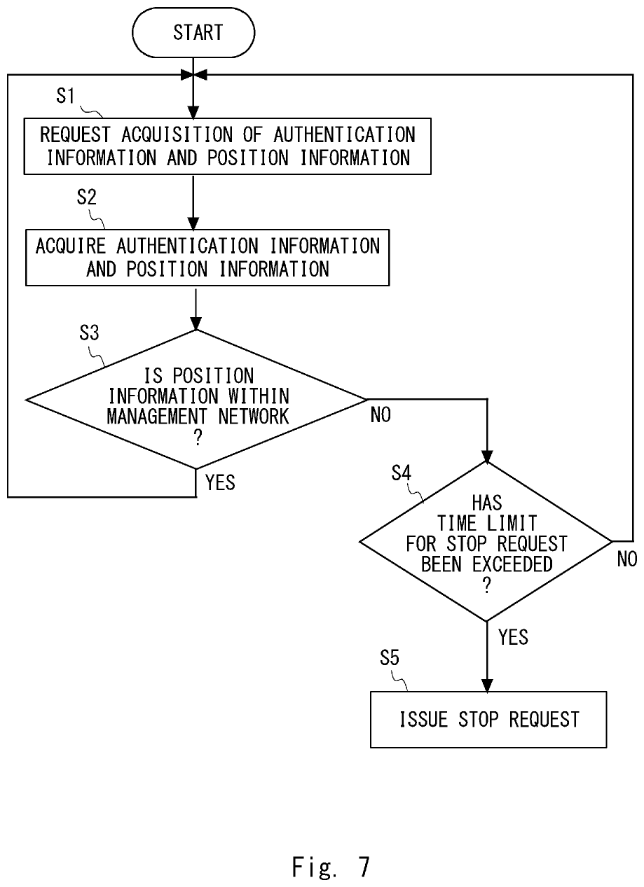

A description is given of an example of the operation in this example embodiment with reference to FIGS. 5 to 7, assuming that the fixed radio transmission apparatus 10 managed in a management network is operated outside the management network. FIG. 5 is a diagram showing an example of a network configuration in the transmission system according to this example embodiment, FIG. 6 is a block diagram for explaining a flow of control performed between the fixed radio transmission apparatuses in the transmission system shown in FIG. 5, and FIG. 7 is a flowchart for explaining the flow of control.

As a premise, the fixed radio transmission apparatus 10 (a monitoring apparatus 10a shown in FIGS. 5 and 6) that performs monitoring has acquired in advance authentication information and position information of another fixed radio transmission apparatus 10 (e.g., the fixed radio transmission apparatus 10b shown in FIGS. 5 and 6) belonging to its own management network 30. The management network 30 is a network for performing radio communication by the first radio communication scheme (exemplified by FWA communication). The monitoring apparatus 10a sets the fixed radio transmission apparatus 10b or the like, which can be stolen as a result of loss or the like (i.e., which can be a stolen apparatus 10b), to be an apparatus to be monitored, and acquires authentication information and position information of the fixed radio transmission apparatus 10b. Note that the position information may not be acquired in advance. Further, in the above acquisition of the authentication information in advance, instead of being acquired from the other fixed radio transmission apparatus 10 itself to be objected, the authentication information may be acquired from paths other than that of the other fixed radio transmission apparatus 10. The processing described below can be executed, for example, by the control unit 11 (or the management control unit 11b) of the monitoring apparatus 10a in cooperation with other components of the monitoring apparatus 10a.

The monitoring apparatus 10a requests authentication information and position information from the fixed radio transmission apparatus 10 (the opposing apparatus) to be monitored (Step S1). Then, the monitoring apparatus 10a acquires the authentication information and the position information (Step S2). For example, the monitoring apparatus 10a requests acquisition of the authentication information and the position information from the stolen apparatus 10b to be managed that is assumed to be used at a place different from the position indicated by the position information. Referring to FIG. 6, for example, the control unit 11 requests acquisition of authentication information (processing i), acquires the authentication information and position information from the management control unit 11b of the stolen apparatus 10b, and notifies the management control unit 11b of the monitoring apparatus 10a about the acquired authentication information and position information (processing ii).

The monitoring apparatus 10a determines whether the acquired position information is within the management network 30, for example, by comparing it with information of an area of the management network 30 stored in advance (Step S3), and if YES in Step S3, the process returns to Step S1 and the above processes are repeated. In Step S3, in order to check whether the apparatus is one to be monitored, it is possible to determine whether the apparatus to be monitored is located within the management network 30 by comparing the acquired authentication information with the stored authentication information.

If NO in Step S3, that is, if there is a possibility that the fixed radio transmission apparatus 10b has been stolen and serves as the stolen apparatus 10b as shown in FIG. 5, the monitoring apparatus 10a determines whether the count of the timer 11a has exceeded the time limit for a stop request (whether a certain period of time has elapsed) (Step S4). The processes in Steps S3 and S4 include specification of whether the apparatus to be monitored is the stolen apparatus and monitoring of the time limit (the period) for a stop request, and as shown in FIG. 6, these processes are mainly performed by the control unit 11 as processing iii. The aforementioned period is a period during which it is not regarded that the case in which the apparatus to be monitored is temporarily moved to the outside of the management network 30 is a case in which it has been stolen, and this period can be set to any length by the administrator or the like. If NO in Step S4, the monitoring apparatus 10a returns to Step S1 and repeats the above processes.

On the other hand, if YES in Step S4, the monitoring apparatus 10a performs control for issuing a stop request to the opposing apparatus (Step S5). For example, the control unit 11 controls the LPWA modem unit 12 so as to transmit a stop signal to the stolen apparatus 10b (processing iv). Upon receiving the stop signal, the control unit 11 of the stolen apparatus 10b autonomously stops the radio wave input/output unit 16 from inputting and outputting microwaves, for example, by way of the microwave modem unit 15 (processing iv). In addition to such stop control, the control unit 11 can also stop the input and output of microwaves by controlling the power supply unit 17 so as to stop supplying power to the baseband unit 14, the microwave modem unit 15, and the radio wave input/output unit 16.

As described above, the monitoring apparatus 10a acquires in advance authentication information and position information of the fixed radio transmission apparatus in the management network 30, and compares pieces of the acquired authentication information and position information with pieces of authentication information and position information acquired from the opposing fixed radio transmission apparatus. Further, when the authentication information pieces match each other and position information outside the management network 30 has been acquired, the monitoring apparatus 10a determines that this fixed radio transmission apparatus, for example, has been stolen, and issues a stop request to this fixed radio transmission apparatus. By such control, the monitoring apparatus 10a can determine (specify) whether a fixed radio transmission apparatus 10 other than the fixed radio transmission apparatus 10a is a stolen apparatus, and if it is a stolen apparatus, the monitoring apparatus 10a can perform stop control of the stolen apparatus.

As described above, according to this example embodiment, it is possible to obtain effects similar to those in the first example embodiment. That is, according to this example embodiment, when a radio transmission apparatus is stolen and is used through another station in a state where a radio transmission path (a normally used radio transmission path) is not established, it is possible to recognize this fact or to perform stop control of the stolen radio transmission apparatus. Further, according to this example embodiment, when the normally used radio transmission path cannot be used, it is possible to use a wide-area radio transmission scheme (LPWA or the like), secure a transmission path for acquiring a minimum amount of authentication information and position information and performing stop control, and then specify the stolen apparatus and perform stop control.

Further, when authentication processing is successfully executed and a position of another fixed radio transmission apparatus indicated by the position information is not included in a predetermined area, and the position of the other fixed radio transmission apparatus is still not included in the predetermined area even after an elapse of a predetermined period of waiting, the control unit 11 controls the other fixed radio transmission apparatus so as to stop a radio output. By further performing such control, it is possible to prevent a case where the apparatus to be monitored is only temporarily moved to the outside of the management network 30 from being regarded as a case in which it has been stolen (i.e., it is possible to prevent the apparatus from being stopped).

### THIRD EXAMPLE EMBODIMENT

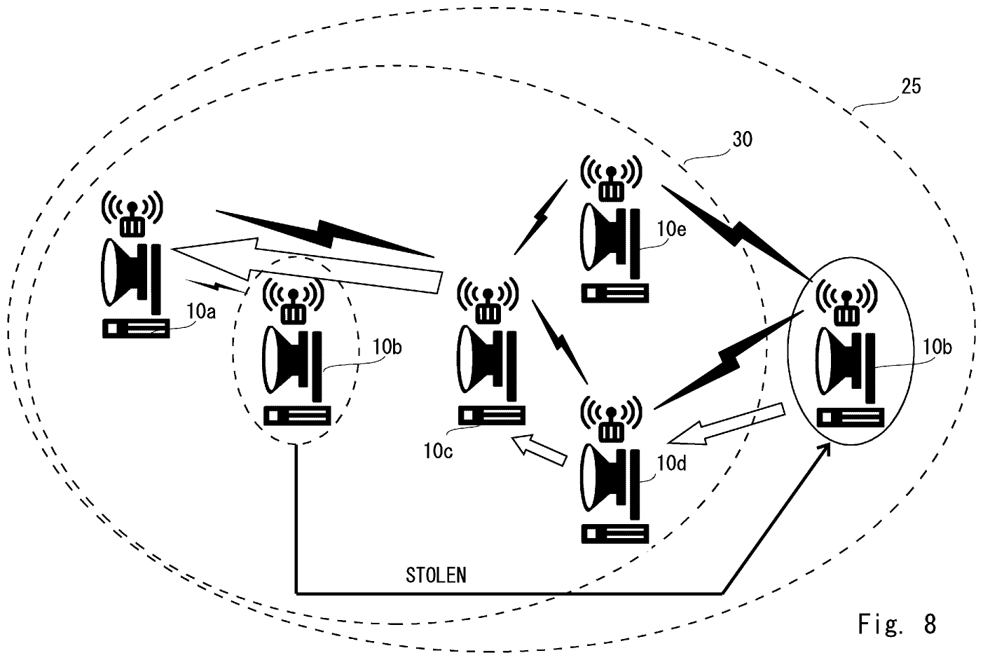

A third example embodiment is described with reference to FIG. 8, with a focus on differences between it and the second example embodiment, including differences in their respective effects. Various examples described in the first and the second example embodiments can be applied to the third example embodiment. FIG. 8 is a diagram showing an example of a configuration of a transmission system according to the third example embodiment.

A description has been given of an example in which one fixed radio transmission apparatus 10 directly monitors and controls another fixed radio transmission apparatus 10 in the transmission system according to the second example embodiment. Meanwhile, in the transmission system according to this example embodiment, as shown in FIG. 8, specification of stolen apparatuses within a wide range and stop control are performed via a plurality of fixed radio transmission apparatuses 10. Note that in FIG. 8, the LPWA base station is not shown.

Specifically, the transmission system illustrated in FIG. 8 includes five fixed radio transmission apparatuses 10a to 10e. FIG. 8 shows a situation in which the fixed radio transmission apparatus 10b goes out of the management network 30. Even in such a situation, if the fixed radio transmission apparatus 10b is located within an LPWA cell 25, the fixed radio transmission apparatus 10a can acquire authentication information and position information of the fixed radio transmission apparatus 10b, for example, via the fixed radio transmission apparatuses 10c and 10d as shown by an outline arrow in FIG. 8. Thus, the fixed radio transmission apparatus 10a can stop the fixed radio transmission apparatus 10b from inputting and outputting microwaves, for example, by way of the fixed radio transmission apparatuses 10c and 10d.

As described above, according to this example embodiment, effects similar to those in the first and second example embodiments can be obtained by control through radio transmission apparatuses other than the radio transmission apparatus that performs monitoring located within the management network.

### FOURTH EXAMPLE EMBODIMENT

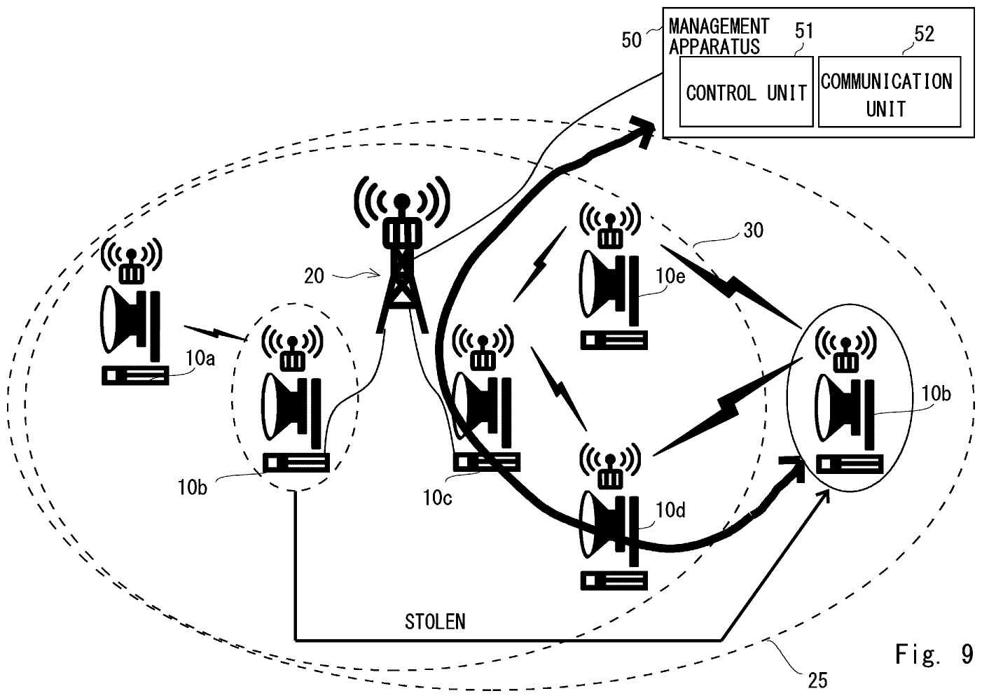

A fourth example embodiment is described with reference to FIG. 9, with a focus on differences between it and the third example embodiment including its effects. Various examples described in the first to the third example embodiments can be applied to the fourth example embodiment. FIG. 9 is a diagram showing an example of a configuration of a transmission system according to the fourth example embodiment.

A description has been given of an example in which one of the fixed radio transmission apparatuses functions as a management apparatus (a monitoring apparatus) to specify a stolen apparatus and perform stop control of the input and output of microwaves in the transmission system according to the third example embodiment (and the transmission system according to the second example embodiment). Meanwhile, in the transmission system according to this example embodiment, a network configuration is managed by a remote management apparatus, the fixed radio transmission apparatus of which the position information is outside the management network 30 is specified, and stop control is remotely performed.

A management apparatus 50 included in the transmission system according to this example embodiment can be, for example, a computer such as a PC. The management apparatus 50 includes a control unit 51 and a communication unit 52 which are described below. The communication unit 52 communicates with a radio transmission apparatus (exemplified by the fixed radio transmission apparatuses 10a to 10e) capable of performing radio communication by the first and the second radio communication schemes via a base station (exemplified by the LPWA base station 20) for performing radio communication by the second radio communication scheme. The management apparatus 50 may be configured to communicate with the LPWA base station 20 either through a wire or wirelessly. It should be noted that FWA communication is used as an example of the first radio communication scheme and LPWA communication is used as an example of the second radio communication scheme, but these are merely examples.

The control unit 51 performs communication with the fixed radio transmission apparatus 10b which can perform radio communication by FWA communication and LPWA communication and in which a transmission path is not established with the fixed radio transmission apparatus 10a by FWA communication. Here, the control unit 51 performs communication including LPWA communication using the communication unit 52 as illustrated by a thick curved arrow in FIG. 9. As in the case of the third example embodiment, this communication may be communication via a plurality of fixed radio transmission apparatuses.

Then, by the aforementioned communication, the control unit 51 acquires authentication information and position information from the fixed radio transmission apparatus 10b and executes authentication processing of the fixed radio transmission apparatus 10b. Further, by the aforementioned communication, the control unit 51 controls the fixed radio transmission apparatus 10b so as to stop a radio output when the authentication processing is successfully executed and the position of the fixed radio transmission apparatus 10b indicated by the position information is not included in a predetermined area.

According to this example embodiment, effects similar to those in the first to the third example embodiments can be obtained through one or a plurality of radio transmission apparatuses under the control of the management apparatus. For example, even when a user has lost a mobile terminal apparatus and the lost mobile terminal apparatus is moved out of the communication area of the first radio communication scheme, it is possible to request the management apparatus to perform stop control from a second mobile terminal apparatus or other PCs, thereby enabling the management apparatus to perform stop control.

### OTHER EXAMPLE EMBODIMENTS

[a]

In the example embodiments, the functions of the components of the radio transmission apparatus 1 shown in FIG. 1, the fixed radio transmission apparatus 10 shown in FIG. 3, and the management apparatus 50 shown in FIG. 9 have been described. However, each of the radio transmission apparatus 1, the fixed radio transmission apparatus 10, and the management apparatus 50 may have any configuration in which these functions can be achieved. Further, the radio transmission apparatus 1, the fixed radio transmission apparatus 10, and the management apparatus 50 are not limited to those that obtain authentication information and position information through the exemplified path, and these apparatuses are also not limited to those that perform stop control through the exemplified path. For these paths, at least a transmission path other than a transmission path using the first radio communication scheme may be used.

Further, in the second to the fourth example embodiments, the fixed radio transmission apparatus 10 used in a backhaul of a mobile communication network or the like has been described as an example, but a radio transmission apparatus that covers a narrow area such as a WiFi base station may instead perform processing similar to that performed by the fixed radio transmission apparatus 10. Note that a WiFi base station is an apparatus that is generally connected to an Internet line and provides Internet services. When management information of the WiFi base station is transmitted through an Internet network, security measures such as a Virtual Private Network (VPN) are required. However, as described in the second example embodiment, by transmitting information such as authentication information of the WiFi base station through the LPWA transmission path, it is possible to securely perform monitoring and control through a unique radio network instead of through the Internet network.

[b]

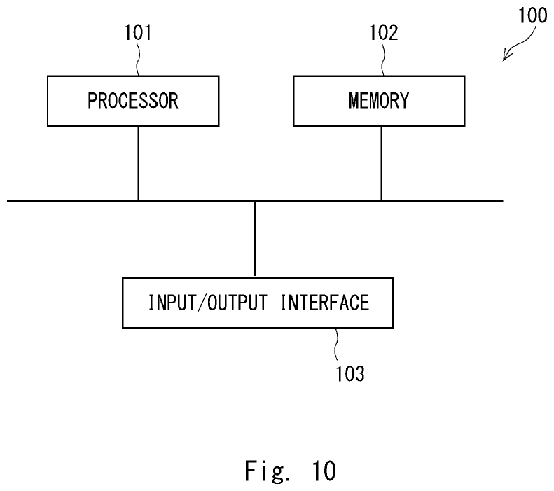

Each of the radio transmission apparatus 1, the fixed radio transmission apparatus 10, and the management apparatus 50 according to the first to the fourth example embodiments may have the following hardware configuration. FIG. 10 is a diagram showing an example of the hardware configuration of each of the apparatuses 1, 10, and 50. Note that the same applies to the other example embodiment [a] above.

An apparatus 100 shown in FIG. 10 can include a processor 101, a memory 102, and an input/output interface 103. The processor 101 may be, for example, a microprocessor, a Micro Processor Unit (MPU), or a Central Processing Unit (CPU). The processor 101 may include a plurality of processors. The memory 102 is composed of, for example, a combination of a volatile memory and a non-volatile memory. Each of the functions of the control units 1a, 11, and 51 of the respective apparatuses 1, 10, and 50 described in the first to the fourth example embodiment may be implemented by the processor 101 loading and executing a control program stored in the memory 102. At this time, the input and output of information can be performed via the input/output interface. The control program can be a program for causing the processor 101 to function as any of the control units 1a, 11, and 51.

In the above-described examples, the control program can be stored using any type of non-transitory computer readable media and provided to a computer. Non-transitory computer readable media include any type of tangible storage media. Examples of the non-transitory computer readable media include a magnetic recording medium (such as a flexible disk, a magnetic tape, and a hard disk drive) and a magneto-optic recording medium (such as a magneto-optic disk). Further, the examples of the non-transitory computer readable media include CD-ROM (Read Only Memory), CD-R, and CD-R/W. Further, the examples of the non-transitory computer readable media include a semiconductor memory, such as a mask ROM, a PROM (Programmable ROM), an EPROM (Erasable PROM), a flash ROM, and a RAM (Random Access Memory). The control program may be provided to the computer by using various types of transitory computer readable media. Examples of the transitory computer readable media include an electrical signal, an optical signal, and an electromagnetic wave. The transitory computer readable media can provide the control program to the computer via a wired communication line (e.g., electric wires, and optical fibers) or a wireless communication line.

[c]

Further, the present disclosure may also take a form of a transmission method, as exemplified by the steps of the transmission method performed by the radio transmission apparatus and the steps of the transmission method performed by the management apparatus in the above-described example embodiments. As each of these transmission methods is characterized by a management method or a monitoring method (a monitoring control method), they can each be referred to as a management method or a monitoring method. These transmission methods may include a detection step and a control step, which will be described below.

In the detection step, the following detection is performed. The radio transmission apparatus capable of performing radio communication by the first and the second radio communication schemes detects that a transmission path using the first radio communication scheme is not established with another radio transmission apparatus capable of performing radio communication by the first and the second radio communication schemes. At this time, the radio transmission apparatus can also perform the detection, for example, upon receiving a request from the management apparatus. In the control step, the radio transmission apparatus, or the management apparatus connected to the radio transmission apparatus via the base station for performing radio communication using the second radio communication scheme, communicates with the other radio transmission apparatus in which it is detected that the transmission path is not established. This communication can be performed directly or through another new radio transmission apparatus, and may be any communication including radio communication using at least the second radio communication scheme. In the control step, authentication information and position information are acquired from the other radio transmission apparatus by this communication, and authentication processing of the other radio transmission apparatus is executed. In the control step, control is performed so that a radio output of the other radio transmission apparatus is stopped when the authentication processing is successfully executed and the position of the other radio transmission apparatus indicated by the position information is not included in a predetermined area. Note that other examples of the transmission method are as described in the above various example embodiments. Further, it can be said that the control program is a program for causing a computer of the radio transmission apparatus or a computer of the management apparatus to perform the detection step and the control step described above.

Note that the present disclosure is not limited to the above-described example embodiments and can be modified as appropriate without departing from the spirit of the present disclosure. Further, the present disclosure may be implemented by combining those example embodiments as appropriate.

While the present disclosure has been described with reference to the example embodiments, the present disclosure is not limited to the aforementioned example embodiments. Various changes that can be understood by those skilled in the art can be made to the configurations and the details of the present disclosure within the scope of the present disclosure.

This application is based upon and claims the benefit of priority from Japanese patent application No. 2018-112049, filed on Jun. 12, 2018, the disclosure of which is incorporated herein in its entirety by reference.

### REFERENCE SIGNS LIST

1 RADIO TRANSMISSION APPARATUS
1a, 11 CONTROL UNIT
1b FIRST RADIO COMMUNICATION UNIT
1c SECOND RADIO COMMUNICATION UNIT
10 FIXED RADIO TRANSMISSION APPARATUS
10a MONITORING APPARATUS
10a FIXED RADIO TRANSMISSION APPARATUS (MONITORING APPARATUS)
10b FIXED RADIO TRANSMISSION APPARATUS (STOLEN APPARATUS)
10c, 10d FIXED RADIO TRANSMISSION APPARATUS
11 a TIMER
11b MANAGEMENT CONTROL UNIT
12 LPWA MODEM UNIT
13, 16 RADIO WAVE INPUT/OUTPUT UNIT
14 BASEBAND UNIT
15 MICROWAVE MODEM UNIT
17 POWER SUPPLY UNIT
20 LPWA BASE STATION
25 COVERAGE AREA (LPWA CELL)
30 MANAGEMENT NETWORK
50 MANAGEMENT APPARATUS
51 CONTROL UNIT OF MANAGEMENT APPARATUS
52 COMMUNICATION UNIT
100 APPARATUS
101 PROCESSOR
102 MEMORY
103 INPUT/OUTPUT INTERFACE

1. A radio transmission apparatus comprising:
first radio communication unit for performing radio communication by a first radio communication scheme;
second radio communication unit for performing radio communication by a second radio communication scheme; and
control unit for performing radio communication using the second radio communication unit with another radio transmission apparatus which is configured to be able to perform radio communication by the first and the second radio communication schemes and in which a transmission path is not established with the radio transmission apparatus by the first radio communication unit, acquiring authentication information and position information from the other radio transmission apparatus, executing authentication processing of the other radio transmission apparatus, and controlling the other radio transmission apparatus so as to stop a radio output when the authentication processing is successfully executed and a position of the other radio transmission apparatus indicated by the position information is not included in a predetermined area.

2. The radio transmission apparatus according to claim 1, wherein the second radio communication scheme is a radio communication scheme having a wider communication range than that of the first radio communication scheme.

3. The radio transmission apparatus according to claim 1, wherein
the first radio communication scheme is a radio communication scheme in which point-to-point communication is performed, and
the second radio communication scheme is a radio communication scheme in which point-to-multipoint communication is performed.

4. The radio transmission apparatus according to claim 1, wherein the second radio communication scheme is Low Power Wide Area (LPWA) communication.

5. The radio transmission apparatus according to claim 1, wherein when the authentication processing is successfully executed and the position of the other radio transmission apparatus indicated by the position information is not included in the predetermined area, and the position of the other radio transmission apparatus is still not included in the predetermined area even after an elapse of a predetermined period of waiting, the control unit controls the other radio transmission apparatus so as to stop the radio output.

6. A management apparatus comprising:
communication unit for communicating with a radio transmission apparatus configured to be able to perform radio communication by a first radio communication scheme and a second radio communication scheme via a base station for performing radio communication by the second radio communication scheme; and
control unit for performing communication including radio communication by the second radio communication scheme using the communication unit with another radio transmission apparatus which is configured to be able to perform radio communication by the first and the second radio communication schemes and in which a transmission path using the first radio communication scheme is not established with the radio transmission apparatus, acquiring authentication information and position information from the other radio transmission apparatus, executing authentication processing of the other radio transmission apparatus, and controlling the other radio transmission apparatus so as to stop a radio output when the authentication processing is successfully executed and a position of the other radio transmission apparatus indicated by the position information is not included in a predetermined area.

7. (canceled)

8. A transmission method comprising:
causing a radio transmission apparatus configured to be able to perform radio communication by a first radio communication scheme and a second radio communication scheme to detect that a transmission path using the first radio communication scheme is not established with another radio transmission apparatus configured to be able to perform radio communication by the first and the second radio communication schemes; and
causing the radio transmission apparatus, or a management apparatus connected to the radio transmission apparatus via a base station for performing radio communication by the second radio communication scheme to: perform communication including radio communication by the second radio communication scheme with the other radio transmission apparatus in which it is detected that the transmission path is not established; acquire authentication information and position information from the other radio transmission apparatus; execute authentication processing of the other radio transmission apparatus; and control the other radio transmission apparatus so as to stop a radio output when the authentication processing is successfully executed and a position of the other radio transmission apparatus indicated by the position information is not included in a predetermined area.

9. (canceled)
